(19) United States
(12) Patent Application Publication
(10) Pub. No.: US 2004/0059625 A1
(43) Pub. Date: Mar. 25, 2004

(54) Method for providing feedback to advertising on interactive channels

(75) Inventor: David K. Schrader, Hermosa Beach, CA (US)

Correspondence Address: JAMES M. STOVER, NCR CORPORATION, 1700 SOUTH PATTERSON BLVD, WHQ4, DAYTON, OH, 45479, US

(73) Assignee: NCR Corporation

(21) Appl. No.: 10/251,118

(22) Filed: Sep. 20, 2002

(51) Int. Cl. G06F 17/60

(52) U.S. Cl. 705/10

(57) ABSTRACT

A method for obtaining feedback from consumers receiving an advertisement from an ad provider through an interactive channel, such as the Internet, interactive television or an interactive kiosk or ATM. The method includes the steps of creating a feedback panel including one or more pre-planned responses fitting said advertisement and linking the feedback panel via an icon with the advertisement delivered to consumers. The feedback panel can thereafter be displayed and activated by a consumer to provide a selected feedback response concerning the advertisement, or possibly an open-ended text response, back to the ad provider through the interactive channel. If the interactive channel is the Internet and the advertisement is contained within a web page displayed on a web-enabled personal computer, the feedback panel can be displayed in response to the consumer selecting a feedback icon displayed as part of the advertisement. Feedback can be used by ad providers to modify advertisements and advertising campaigns, to discontinue advertising to selected consumers, or refine the target audience selected to receive advertisements.

The present invention relates to interactive communication systems such as the Internet, and in particular, to methods for gathering consumer feedback to advertisements presented through interactive channels and altering marketing campaigns in response to consumer feedback.

### BACKGROUND OF THE INVENTION

Usage of the Internet, and more specifically the World Wide Web, (Web) has greatly increased during the last few years. Many universities, government organizations, companies, and individuals have Web sites offering a wealth of information to anyone with internet access and Web browser software. This information includes news, company and product information, stock quotes, airline flight schedules, movie reviews, job opportunities, and opportunities to purchase products and services.

Web browsers, such as Microsoft Corporation's Internet Explorer internet browser and Netscape Communications Corporation's Navigator™ internet browser, provide a graphical, easy-to-navigate interface for retrieving and viewing information available from the Web. The World Wide Web utilizes a system known as a hypertext system to facilitate navigation through the World Wide Web environment. The hypertext system employs special connections, or links, which are embedded into documents displayed through use of internet browser software. Clicking on a word, phrase, image or thumbnail graphic including one of these links instructs the browser to retrieve a document, graphic, sound, or other information associated with the embedded link.

As the popularity of the Internet and the World Wide Web has increased, so has the use of the Internet as a medium for advertising products and services. Internet ads may take the form of banner ads, pop-up and pop-under windows, interstitials, or images embedded into web pages. Most of these ads contain links to the advertisers' web sites. Advertising rates may be determined by a count of the number of times that a Web page containing the advertisement is displayed, a count of the number of visits that a business Web page receives as a result of a click-through from the original Web page advertisement, or even the amount of sales activity that an advertisement generates.

In many cases, internet advertising supports “free” services for consumers such as search engines or websites filled with useful information. However, much advertising is irrelevant and therefore ignored by consumers. Poorly focused advertising can negatively impact consumers, advertisers, and distributors.

For the consumer, the problems manifest themselves as too much clutter interfering with and confusing browsing activities, slower response times during web browsing activities, less requested content displayed during browsing activities, and a greater use of resources such as bandwidth and disk space.

For the marketer or advertiser, the problems include increased advertising expenses, increased complexity in deciding which channels to use to convey messages/advertising to consumers, reduced effectiveness of advertisements as over-messaging to consumers means that they screen out most advertising, lower return on advertising investments resulting from the combination of increased expense and decreased response rates, and increased risk of consumer backlash or legislation as consumers react to an overdose of irrelevant advertising.

For the owners of a distribution network, such as a portal like Yahoo, or an ad network like DoubleClick, or a roll-your-own website, the problems show up as customer attrition. If advertising becomes too annoying, customers may move to a website with less advertising, opt to pay a subscription fee to avoid advertising-supported channels, or use devices such as firewalls and ad zappers to screen out all advertising. Customer attrition will lead to advertiser attrition. If the distributor cannot deliver viewers, then advertisers elect not to use that channel.

Although methods exist for determining the exposure of an ad, or in some cases for determining the success of an ad in directing visitors to a business' Web page, a method for collecting “negative” feedback from ad recipients and thereby more precisely gauging consumer interest in an advertisement or product is desired by ad providers, distributors and businesses. With a better understanding of consumers' reactions to product advertisements, advertising campaigns can be modified and targeted to be less intrusive, better received by the consumers, and more effective.

### OBJECTS OF THE INVENTION

It is therefore an object of the present invention to provide a new and useful method for obtaining consumer feedback to advertising delivered through interactive channels.

It is also an object of the present invention to obtain a better understanding of consumers' reactions to product advertisements, and utilize this understanding to modify and target advertising so as to be less intrusive, better received by the consumers, more timely, and more effective.

It is another object of the present invention to provide a new and useful method for developing and updating marketing or advertising campaigns that utilize interactive channels, such as the Internet, by including the solicitation and consideration of consumer feedback in the development and updating of marketing or advertising campaigns.

### SUMMARY OF THE INVENTION

There is provided, in accordance with the present invention, a method for obtaining feedback from consumers receiving an advertisement from an ad provider through an interactive channel, such as the Internet, interactive television or an interactive kiosk or ATM. The method includes the steps of creating a feedback panel containing one or more pre-planned responses fitting to the advertisement; and delivering the feedback panel, or access to the feedback panel, with the advertisement delivered to consumers. The feedback panel can thereafter be activated by a consumer to provide a selected feedback response concerning the advertisement, or possibly an open-ended text response, back to the ad provider through the interactive channel.

If the interactive channel is the Internet and the advertisement is contained within a web page displayed on a web-enabled personal computer, the feedback panel can be displayed in response to the consumer selecting a feedback icon displayed as part of the advertisement.

Also described herein, is a method for developing and maintaining an advertising campaign, comprising the steps of composing an advertisement for display to consumers through an interactive channel; designing a feedback panel and including the feedback panel with the advertisement delivered to consumers, the feedback panel being activated by a consumer to provide a feedback response concerning the advertisement to an ad provider through the interactive channel; collecting responses received from the consumers receiving the advertisement; and modifying the advertising campaign in response to the feedback received from the consumers. Feedback responses can be collected in a database for storage and analysis. Modifications to the advertising campaign in response to feedback received from consumers may include immediate or deferred discontinuation of advertising to selected consumers, changes to the advertisements, or refinement of the target audience selected to receive ads. These modifications can be done manually by marketing employees, or automatically through Customer Relationship Management (CRM) software.

The above and other objects, features, and advantages of the present invention will become apparent from the following description and the attached drawings.

### BRIEF DESCRIPTION OF THE DRAWINGS

FIG. 1 is an illustration of a Microsoft Internet Explorer Internet browser application window displaying a portion of an exemplary WWW hypertext document containing numerous embedded, banner and pop-up advertisements.

FIG. 2 is a simple block diagram illustration of a process for creating and distributing advertisements to consumers through an interactive channel.

FIG. 3 is a simple block diagram illustration of an improved process for creating and distributing advertisements to consumers through an interactive channel that includes solicitation and consideration of consumer feedback in the process in accordance with the present invention.

FIG. 4 is a flow diagram of the improved process for creating and distributing advertisements to consumers through an interactive channel that incorporates solicitation and consideration of consumer feedback in the process in accordance with the present invention.

FIG. 5 is an exemplary banner ad taken from the web page illustrated in FIG. 1.

FIG. 6 shows the exemplary banner ad of FIG. 5, annotated with a stoplight icon identifying the advertisement as one to which a viewer can provide feedback, and providing the mechanism for feedback to be provided in accordance with one embodiment of the present invention.

FIG. 7 shows the exemplary banner ad of FIG. 6 including a pop-up feedback panel activated in response to selection of the feedback icon in accordance with one embodiment of the present invention.

### DETAILED DESCRIPTION OF THE PREFERRED EMBODIMENT

The following description is presented to enable any person skilled in the art to make and use the invention, and is provided in the context of a particular application and its requirements. Various modifications to the preferred embodiments will be readily apparent to those skilled in the art, and the principles defined herein may be applied to other embodiments and applications without departing from the spirit and scope of the invention. Thus, the present invention is not intended to be limited to the embodiments shown, but is to be accorded with the broadest scope consistent with the principles and features disclosed herein.

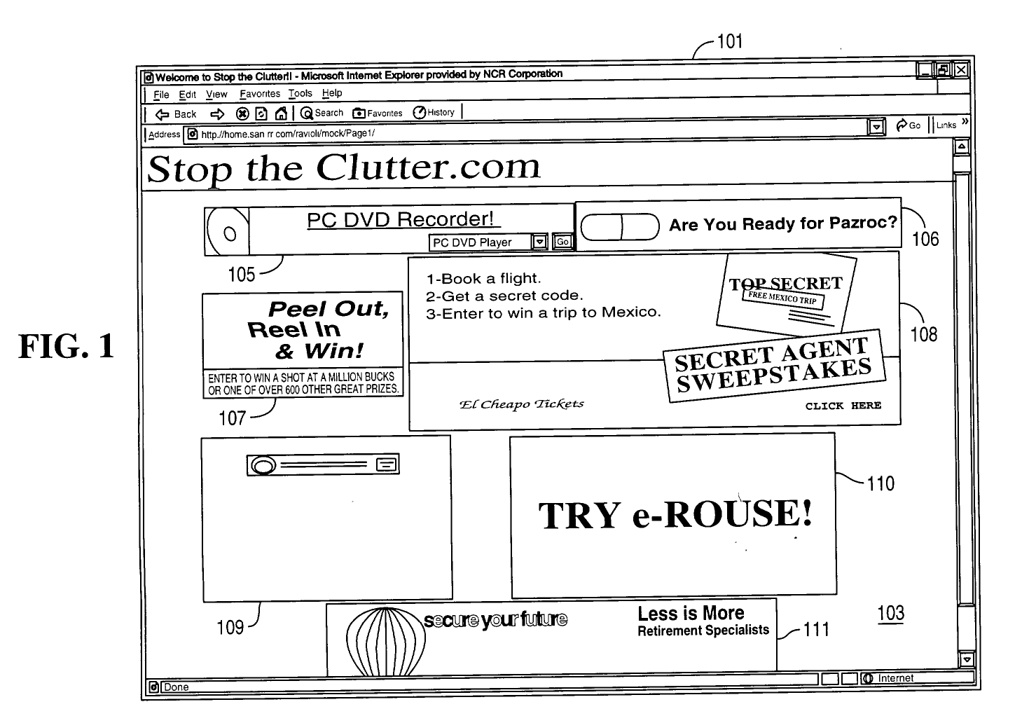

Referring now to FIG. 1, there is seen a Microsoft Internet Explorer Internet browser application window 101 displaying a portion of an exemplary WWW hypertext document 103. The displayed web page is provided for illustration only, containing numerous embedded, banner and pop-up advertisements 105 through 111. Although impossible to show in a static drawing, some of these ads may flash, scroll, change color, include audio or animation, or alternate with other advertisements in an effort to gain a viewer's attention, but further adding to the clutter and confusion presented to the viewer.

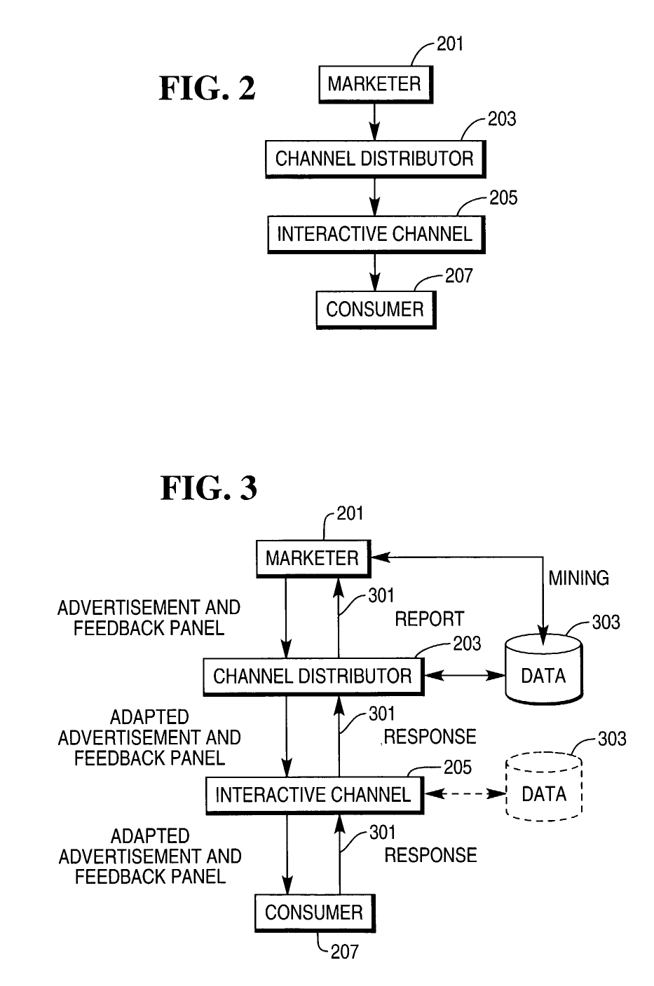

Referring to FIG. 2, the process for creating and distributing advertisements to consumers through an interactive channel will now be explained. Development of an advertising campaign plan begins with a marketer 201. The campaign plan specifies a target market, one or more advertisements or messages for the target market, media channel mix choices, and metrics that will be collected to determine campaign effectiveness. The target market includes one or more consumers selected by age, income, browsing or purchase history, geography, or other demographic information, or randomly, that the marketer has identified to receive advertising under the campaign plan. The advertisements/messages developed for the different channels are thereafter provided to one or more channel distributors 203 for incorporation into their respective interactive channels 205 for presentation to potential consumers 207. Channel distributors 203 include internet portals such as Yahoo, internet advertising brokers such as DoubleClick, television and radio networks, etc. The various current and imminent interactive channels 205 include the Internet and World Wide Web, Interactive Television, and self service devices, such as Information Kiosks and Automated Teller Machines (ATMs).

The process for creating and distributing advertisements as described immediately above and illustrated in FIG. 2 is well known and need not be explained further. The block diagram of FIGS. 3, however, illustrates an improved means for creating and distributing advertisements that includes solicitation and consideration of consumer feedback responses in the ongoing development and presentation of advertisements via the interactive channels. As shown in FIG. 3, the improvements include feedback paths 301 from the consumer 207 through the interactive channel 205, to the channel distributor 203 back to the marketer 201, and one or more databases or other storage repositories 303 providing for the collection and analysis of customer feedback information.

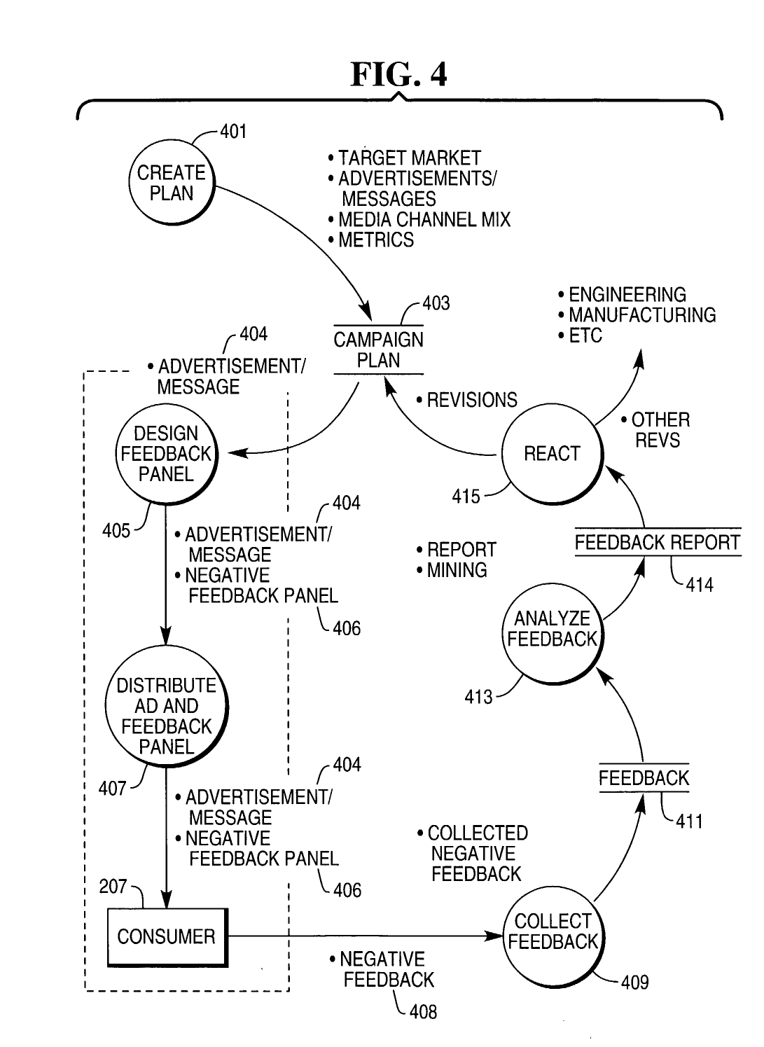

FIG. 4 provides a flow diagram of the improved process for creating and distributing advertisements to consumers through an interactive channel that incorporates solicitation and consideration of consumer responses to advertisements. The process as illustrated in FIG. 4, begins with the development of an advertising campaign plan by the marketer, as indicated by reference numeral 401. The marketer creates a campaign plan 403 that specifies a target market, one or more advertisements or messages 404 for the target market, media channel mix choices, and metrics that will be collected to determine campaign effectiveness. Additionally, for any interactive channels in the media channel mix capable of capturing consumer reaction, the marketer designs a feedback panel 406, as indicated by step 405, so the consumer can easily provide feedback or comment to the advertisements. The feedback panel 406 can be as simple as “I'm not interested” or can provide a variety of pre-planned responses or open-ended answers. Examples of pre-planned responses include:

“I don't want to see any advertising from your company, ever”

“I don't want this product, ever”

“I am interested in this product, but timing would be better in 6 months” (or a consumer-specified interval)

“I don't like this particular ad for your product”

“I'm confused; have someone contact me”

“I'm bored with this ad because you've shown in too many times”.

The feedback panel 406 and an iconic representation are adapted by the channel distributors for each channel and provided through the respective interactive channels to the consumers 207 as indicated by reference numeral 407. There are multiple options for adapting and displaying feedback panel 406 and the icon, depending on the form factors of the channels and the method by which the consumer can be told that the advertisement is feedback-capable. For example:

If the channel is a PC connected to the Internet, the advertisement may be embedded in frames in HTML. In the case of a web-capable PC, the feedback panel may be a display of a menu from which the consumer can select a response to be provided back to the distributor.

If the channel is an Interactive TV, the distributor may download instructions to a television set-top box to display a “feedback icon” on an advertisement when played. Utilizing a television set-top remote control, a consumer may click on the icon to display Negative Feedback questions on the screen in lieu of the remainder of the ad, and select a response to be provided back to the distributor.

If the channel is a bank automated teller machine (ATM), the advertisement may appear as part of the screen sequence while dispensing cash. The advertisement can be engineered to appear next to buttons on the ATM that provide the consumer with an option to “Provide Feedback”.

For some of these channels, feedback panel 406 could be constructed to include non-verbal modalities of feedback. For example, a video camera attached to an ATM, Information Kiosk, or internet-connected PC may drive a program that detects that a consumer is looking at an advertisement and to detect reactions to the ad.

The manner in which a consumer 207 activates a response to an advertisement may vary depending upon the interactive channel, limitations of the device the consumer is interacting through, or choices made in the design and adaptation of the feedback panel. For example:

In the case of a PC connected to the internet, the feedback panel may be activated by a right click on an advertisement or by clicking on an icon included within the advertisement, resulting in a menu for the consumer to click on.

If the channel is an Interactive TV, the feedback panel may be activated by a remote control click when an ad is playing. This may cause a menu to be displayed for the consumer, who uses number buttons on the remote control to select and convey an appropriate response to the ad. Because television has some hard real-time constraints, e.g., thirty-second or one-minute spots for ads, the system may be engineered to gather the feedback within this time interval. For example, a consumer may use the remote control to “zap” an ad, and television set-top box software must correlate the amount of feedback collected to the amount of run-time left for the ad.

If the channel is an ATM, kiosk or other self-service device, there may be a “Feedback” button on the ATM itself that a user pushes to provide feedback either during or after presentation of an ad. Pushing this button may activate a sequence of screens, with various options for feedback that correspond to buttons on the ATM that the consumer can push.

If the channel is a camera-enabled device like a PC, ATM or Kiosk, the consumer reaction may be a frown at irrelevant or annoying advertising.

Feedback provided by consumers is collected by the channel distributors as indicated by reference numeral 409. The captured feedback 411 may be saved to a database 303 or other suitable storage system. The information collected from each consumer can thereafter be tabulated or analyzed as indicated by reference numeral 413, so that each advertisement has a tally of negative feedback, grouped by category. The results of the analysis, referred to as feedback report 414, which may be summary reports, raw data or open-ended customer responses, is provided to the marketer/advertiser by the distributor for advertising campaign revision or other action, as indicated by reference numeral 415. The feedback report 414 may also be saved to database 303 or other suitable storage system for further analysis or archiving.

The marketer/advertiser reacts to the negative feedback by revising the campaign plan 403. This may include future ad suppression for a consumer on one or more channels; adjustment of the target set for the campaign, e.g., by excluding people who reacted negatively; changing the advertising for a particular target, e.g., “tone down” the edginess of the ad; or planning for future advertising for a particular target, such as those who gave feedback indicating that they are not currently interested in a product but may be at a future time.

Normally, the updated campaign plan would be provided to the channel distributors if the ad campaign were an ongoing campaign. Sometimes, however, it may be appropriate to update or augment the feedback panel, or even stop and revise a campaign. Certainly the collected consumer feedback will be useful in planning future campaigns.

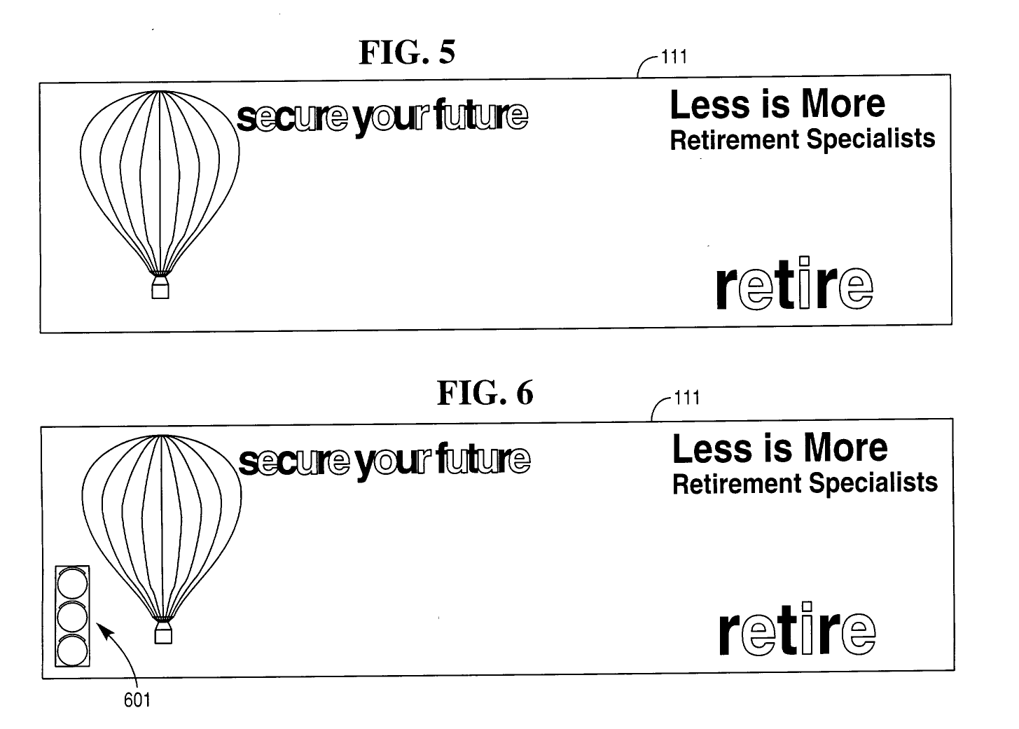

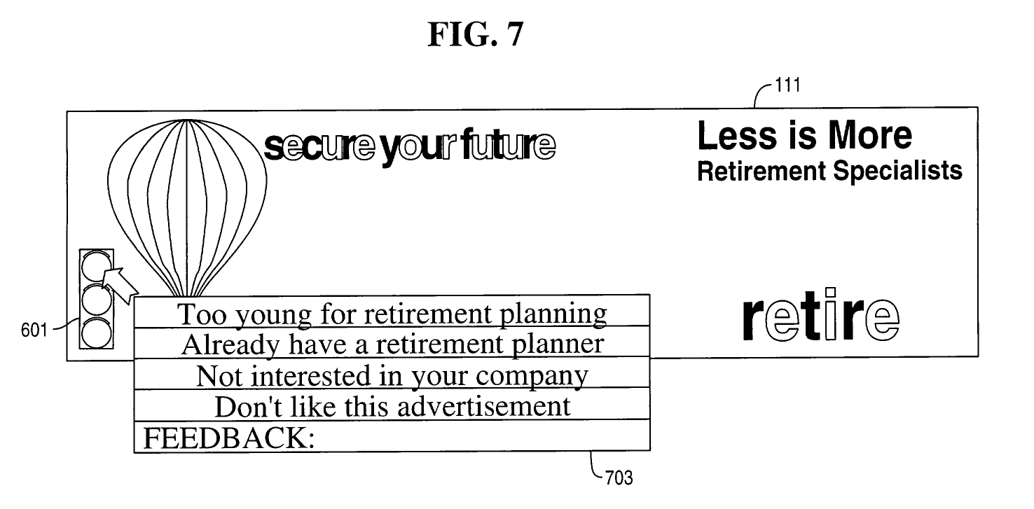

One method for implementing the feedback panel and collecting customer responses to advertisements when the interactive channel is the Internet is illustrated in FIGS. 5 through 7. FIG. 5 shows banner ad 111 for a retirement planning agency. This ad is one of several ads appearing on the web page illustrated in FIG. 1. FIG. 6 shows the same ad 111 annotated with an icon 601, a stoplight, identifying the advertisement as one to which a viewer can provide feedback, and providing a mechanism for feedback to be provided. If the consumer is interested in the advertisement, a double-click on the green portion of stoplight icon 601 will link the consumer to the advertiser's web site. Selection of the red portion of stoplight icon 601, displays a pop-up feedback panel 703 as illustrated in FIG. 7. A viewer can select from several pre-planned responses contained in the feedback panel 703 to be provided back to the ad distributor, or provide an open-ended text response by selecting the last listing in the feedback panel.

An example marketing campaign developed in accordance with the present invention will now be described.

A national car manufacturer, National Motors (NM), is introducing a new car model, the XP23i. The marketing person responsible for the ad campaign, Mary, identified men ages twenty-five to thirty-five, with incomes between $50,000 and $70,000 who drive under two hundred miles per week, as the target market for the new automobile. Mary worked with a creative agency to create print and video ads for magazine, internet, and TV channels. A test marketing campaign was put in place to test the print ads over the Internet for four weeks in the South (Georgia and Alabama) and East (New York), and to test the video ads over cable TV in those two regions.

Mary created negative feedback panels that included the following feedback response possibilities for banner ads delivered over the internet channel:

1. Not interested in any advertising from your company.

2. Not interested because I don't need a new car.

3. Not interested today, but will be interested in <pull down date options>.

4. Not interested in this particular model because of styling.

5. Not interested because of price.

6. Not interested because of missing feature I want <pull down feature options>.

The TV ad feedback panels were shorter because of the 30-second time constraint. The feedback panel for TV included:

1. Not interested (one click option without explanation) (used if under 15 seconds are left in the ad spot)

2. Not interested because

Not in Market for a New Car

Too Expensive

Doesn't Fit My Lifestyle

Other Reason—May We Call You?

A fifth category is created for the case that the user did not have time to click any of these

The test marketing campaigns were launched for a four-week trial period. The NM banner ad was shown a total of 430,000 times in the target geographies. Twenty-eight TV spots were purchased with different variations on NM advertising shown to different viewing segments, and only to those viewers who were cable-connected with next generation set-top boxes permitting interactive feedback.

Consumer Example 1. Among the more than 24,000 internet banner ad feedback items was this one from consumer Craig D: Craig logged into his PC and went to his favorite internet portal. In addition to being a “free” source of all kinds of information, the portal is part of an ad network. When Craig logged into the portal, the portal checked his history and because he was known to fit the demographic profile target filed by the marketer at NM, a banner ad was placed on a frame of the portal home page that Craig viewed. Because Craig recently bought a new car, he wasn't really in the target market, so he right-clicked on the ad, and selected Menu Item 2. This piece of information was captured by the portal in its feedback database for NM campaigns and a few days later accessed by NM's marketing person Mary, who observed that the more than 24,000 responses gathered by the portal are distributed in the following pattern:

1. Not interested in any advertising from your company: 7,987.

2. Not interested because I don't need a new car: 1,888.

3. Not interested today, but will be interested in <pull down date options>:

| | |
|---|---|
| One month from now: | 1,920. |
| 2-3 months from now: | 2,202. |
| 3-6 months from now: | 1,200. |
| 6 months from now or greater: | 3,653. |

4. Not interested in this particular model because of styling: 899.

5. Not interested because of price: 4,021.

6. Not interested because of missing feature I want <pull down feature options>: 330.

Mary took the following actions based on the results from this test:

She revised her target list by removing the people who responded 1, 2, 4, 5, and 6. These people will not see any more banner ads from NM on this model.

She shared the information from 1 and 2 with other NM Marketing people, who would otherwise potentially market their models to the same customer base.

She filed the responses in category 3 for “retouching” the Consumer at a later, more relevant point in time. She filed the responses to category 2 in a 3+ years time horizon for possible later use when the “new” car isn't new any more.

She passed on information from categories 4, 5, and 6 to the product manager, to incorporate that feedback into decisions about future model releases.

The next time Craig logs into his internet portal, he will not see another NM banner ad for this model. The ad network will substitute a different ad into the ad space vacated by the NM advertisement.

Consumer Example 2. Jim S. turned on his television and to watch a rerun of a favorite television series. At the first commercial break, the local cable provider downloaded the national NM car ad to the consumer's set-top box and played the ad. The cable company has demographic and psychographics information, so they only download this particular ad to the ad targets specified by the advertisers. However, because Jim is an employee of a rival automobile company, he will never buy a NM car. He spotted the icon that indicated that the NM ad allows for feedback, so he pushed a button on his remote control and a feedback screen appeared. He selected the option “Other Reason—May We Call You?” for not buying, and pushed one more button to allow NM to call to follow up on the reason. Jim believed that this was a small price to pay for not having to see any NM ads, ever. The cable company collected the remote control clicks and stored them in its database. This information was uploaded to the national advertiser placement agency, which then formatted the information in tabular format and provided the information back to NM. Ultimately, Mary received a copy of this and had some of her employees call people who checked the box allowing a call. Four days later, Jim received a follow-up call during the same commercial break, and he explained why he will never be in the market for a NM product. Mary's people updated their database so that Jim will never be the target of any future NM advertising.

### Conclusion

The solution described above provides for the collection of consumer feedback to advertising delivered through interactive channels. Past methods for determining the success of an ad delivered through interactive channels are limited to “positive” feedback metrics, such as a count of the number of times that a Web page containing the advertisement is displayed, or a count of the number of visits that a business' Web page receives as a result of linking from the original Web page advertisement. The present solution provides for the collection of “negative” feedback, providing an ad provider with a better understanding of consumers' reactions to product advertisements. With this understanding, marketers and advertisers will be able to modify and target advertising so as to be less intrusive, better received by the consumers, more timely, and more effective.

The advantages resulting from utilization of the above-described solution are numerous. It decreases clutter for consumers and increases the probability that they see only relevant advertising. It decreases marketing costs for companies and improves the return on their advertising investments. It improves the effectiveness of ad networks. All 3 constituencies, i.e., consumers, marketers or advertisers, and ad distributors, benefit.

For the consumer, the advantages are:

Less Clutter. Advertising on interactive channels enabled with the above-described technology is susceptible to feedback by consumers. If marketers react by decreasing advertising deemed irrelevant by consumers, substituting more relevant advertising, then life will feel less cluttered.

Better Use of Time. With relevant advertising, chances are that consumers will spend more of the ad interval time listening to ads and reacting positively, e.g., purchasing, asking for more information, and engaging with the advertisement or company behind the ad.

For the marketer or advertiser the advantages include:

Reduced Expense. Since interactive channels can typically target smaller sets of consumers, the overall advertising expense should decrease as marketers “narrow-cast” their messages to the right set of people. With feedback loops, users for whom the advertising irrelevant opt-out, resulting in less overall cost.

Higher Response. Reducing the number of people to those who are interested will improve the probability of positive responses to product offers.

Higher Return on Investment (ROI). The combination of decreased expense and increased response rates means that return on the investment of marketing dollars for advertising is much higher. Fewer ads can be placed with smaller sets of customers, but with a higher response rate, overall ROI goes up.

Decreased Risk of Legislation. Providing free-market feedback loops empowers consumers and decreases the risk that overly-wide government legislation would be passed, endangering the ability to marketers to get their messages to the public.

For the owners of the distribution network, the advantages show up as:

Customer Retention. Any advertising network with negative feedback loop capability increases the probability of customer loyalty since their customers could dynamically adapt the system to their needs. Providing such a service could significantly increase customer satisfaction and help reduce churn of customers compared to other distribution networks without such capability.

Advertiser Services. Providing this service to advertisers opens up a new category of consumer responses that can help with target advertising effectiveness studies, focused feedback groups, and a variety of other possible consumer testing services.

Advertiser Retention. If the ad network can maintain or grow its customer share, this is advantageous in terms of retaining or growing the number of advertisers who use that channel.

Those skilled in the art will recognize that the invention is not limited to the specific embodiment described above and that numerous modifications and changes are possible without departing from the spirit and scope of the present invention. For example, although the discussion presented above refers primarily to the Internet as an interactive channel to which the present invention has application, any current or imminent interactive channel, such as the Internet, interactive television, information kiosks and automated teller machines, will benefit from the process described herein. Thus, the present invention is not intended to be limited to the embodiments shown, but is to be accorded with the broadest scope consistent with the principles and features disclosed herein.

What is claimed is:

1. A method for obtaining feedback from consumers receiving an advertisement from an ad provided through an interactive channel, the method comprising the steps of:
creating a feedback panel including at least one feedback response concerning said advertisement; and
providing said feedback panel to said consumers, said feedback panel being activated by a consumer to provide said feedback response concerning said advertisement to said ad provider through said interactive channel.

2. The method for obtaining feedback from consumers receiving an advertisement from an ad provided through an interactive channel in accordance with claim 1, wherein:
said feedback panel comprises a plurality of pre-planned feedback responses associated with said advertisement.

3. The method for obtaining feedback from consumers receiving an advertisement from an ad provided through an interactive channel in accordance with claim 2, wherein:
said feedback panel further includes means for providing an open-ended text response concerning said advertisement to said ad provider.

4. The method for obtaining feedback from consumers receiving an advertisement from an ad provided through an interactive channel in accordance with claim 1, wherein:
said interactive channel comprises the internet;
said advertisement is contained within a web page displayed on a web-enabled personal computer;
said advertisement includes a feedback icon displayed as part of said advertisement; and
said feedback panel is displayed in response to the consumer selecting said feedback icon.

5. The method for obtaining feedback from consumers receiving an advertisement from an ad provided through an interactive channel in accordance with claim 1, wherein:
said interactive channel comprises interactive television; and
said feedback panel is displayed in response to a consumer request entered by use of a television remote control during the display of said advertisement.

6. The method for obtaining feedback from consumers receiving an advertisement from an ad provided through an interactive channel in accordance with claim 5, wherein:
said advertisement includes a feedback icon displayed as part of said advertisement that identifies said advertisement as one to which said consumer can provide feedback comments.

7. The method for obtaining feedback from consumers receiving an advertisement from an ad provided through an interactive channel in accordance with claim 1, wherein:
said interactive channel comprises a self service device enabled to periodically display said advertisement; and
said feedback panel is displayed in response to a consumer request entered by use of function buttons included on said self service device during the display of said advertisement.

8. The method for obtaining feedback from consumers receiving an advertisement from an ad provided through an interactive channel in accordance with claim 7, wherein:
said advertisement includes a feedback icon displayed as part of said advertisement that identifies said advertisement as one to which said consumer can provide feedback comments.

9. The method for obtaining feedback from consumers receiving an advertisement from an ad provided through an interactive channel in accordance with claim 8, wherein:
said self service device comprises an automated teller machine (ATM).

10. The method for obtaining feedback from consumers receiving an advertisement from an ad provided through an interactive channel in accordance with claim 8, wherein:
said self service device comprises an information kiosk.

11. The method for obtaining feedback from consumers receiving an advertisement from an ad provided through an interactive channel in accordance with claim 1, further comprising the step of:
collecting said feedback responses in a database.

12. The method for obtaining feedback from consumers receiving an advertisement from an ad provided through an interactive channel in accordance with claim 1, further comprising the steps of:
obtaining a feedback response to said advertisement from said consumer; and
halting display of said advertisement to said consumer in response to said feedback response.

13. A method for obtaining feedback from consumers receiving an advertisement from an ad provided through an interactive channel, the method comprising the steps of:
obtaining a video image of said consumer while viewing said advertisement;
identifying an expression by said consumer indicating disapproval of said advertisement;
generating a feedback response indicating disapproval of said advertisement; and
providing said feedback response to said ad provider through said interactive channel.

14. The method for obtaining feedback from consumers receiving an advertisement from an ad provided through an interactive channel in accordance with claim 13, wherein:
said interactive channel comprises the internet; and
said advertisement is contained within a web page displayed on a web-enabled personal computer including a video camera.

15. The method for obtaining feedback from consumers receiving an advertisement from an ad provided through an interactive channel in accordance with claim 13, wherein:
said interactive channel comprises a camera-equipped self service device enabled to periodically display said advertisement.

16. The method for obtaining feedback from consumers receiving an advertisement from an ad provided through an interactive channel in accordance with claim 15, wherein:
said self service device comprises an automated teller machine (ATM).

17. The method for obtaining feedback from consumers receiving an advertisement from an ad provided through an interactive channel in accordance with claim 15, wherein:
said self service device comprises an information kiosk.

18. A method for developing and maintaining an advertising campaign, comprising the steps of:
composing an advertisement for display to consumers through an interactive channel;
composing a feedback panel and including said feedback panel with said advertisement delivered to said consumers, said feedback panel being activated by a consumer to provide a feedback response concerning said advertisement to an ad provider through said interactive channel;
collecting feedback responses received from said consumers; and
modifying said advertising campaign in response to the feedback responses received from said consumers.

19. The method for developing and maintaining an advertising campaign in accordance with claim 18, wherein:
said feedback panel comprises a plurality of pre-planned feedback responses associated with said advertisement.

20. The method for developing and maintaining an advertising campaign in accordance with claim 19, wherein:
said feedback panel further includes means for providing an open-ended text response concerning said advertisement to said ad provider.

21. The method for developing and maintaining an advertising campaign in accordance with claim 18, wherein:
said interactive channel comprises the internet;
said advertisement is contained within a web page displayed on a web-enabled personal computer;
said advertisement includes a feedback icon displayed as part of said advertisement; and
said feedback panel is displayed in response to the consumer selecting said feedback icon.

22. The method for developing and maintaining an advertising campaign in accordance with claim 18, wherein:
said interactive channel comprises interactive television; and
said feedback panel is displayed in response to a consumer request entered by use of a television remote control during the display of said advertisement.

23. The method for developing and maintaining an advertising campaign in accordance with claim 18, wherein:
said interactive channel comprises an automated teller machine (ATM) enabled to periodically display said advertisement; and
said feedback panel is displayed in response to a consumer request entered by use of said ATM function buttons during the display of said advertisement.

24. The method for developing and maintaining an advertising campaign in accordance with claim 18 further comprising the step of:
collecting said feedback responses in a database.

25. The method for developing and maintaining an advertising campaign in accordance with claim 18, wherein said step of modifying said advertising campaign in response to the feedback responses received from said consumers includes the step of:
discontinuing advertising to selected consumers.

26. The method for developing and maintaining an advertising campaign in accordance with claim 18, wherein said step of modifying said advertising campaign in response to the feedback responses received from said consumers includes the step of:
modifying the advertisement provided said consumers through said interactive channel.
